(19) United States
(12) Patent Application Publication
(10) Pub. No.: US 2007/0140916 A1
(43) Pub. Date: Jun. 21, 2007

(54) CONDITIONING DEVICE FOR LIQUID HANDLING SYSTEM LIQUIDS

(76) Inventor: Markus Spiss, Zurich (CH)

Correspondence Address: NOTARO AND MICHALOS, 100 DUTCH HILL ROAD, SUITE 110, ORANGEBURG, NY, 10962-2100, US

(21) Appl. No.: 11/612,552

(22) Filed: Dec. 19, 2006

Related U.S. Application Data
(60) Provisional application No. 60/751,780, filed on Dec. 20, 2005.

(30) Foreign Application Priority Data
Dec. 20, 2005 (CH) CH 02015/05

(51) Int. Cl. B01L 3/02

(52) U.S. Cl. 422/100

(57) ABSTRACT

A device for conditioning a system liquid for a liquid handling apparatus has a degassing chamber for degassing the system liquid, with a system liquid injection point, a system liquid drain line and a gas train line. The device has a collection chamber for degassing liquid, which is separated from the degassing chamber and is connected via a recirculation pump to the system liquid drain line. At least one such device can be integrated into a mobile facility for conditioning a system liquid for a liquid handling apparatus. A liquid handling workstation having at least one such liquid handling apparatus for pipetting or dispensing liquid samples with the aid of a system liquid or such a liquid handling apparatus may also comprise at least one such device.

### RELATED APPLICATIONS

This patent application claims benefit of the priority of the U.S. Provisional Application No. 60/751,780 and of the Swiss Patent Application No. CH 2005 02015/05, both filed on Dec. 20, 2005. The disclosure of these two priority applications is introduced into this patent application in their entirety and for all purposes by explicit reference.

### RELATED FIELD OF TECHNOLOGY

The present invention relates to a device for conditioning a system liquid for a liquid handling apparatus according to the preamble of independent claim 1, which comprises a degassing chamber for degassing a system liquid, the degassing chamber comprising a system liquid injection point, a system liquid drain line, and a gas drain line.

Industrial branches, which are concerned with pharmaceutical research and/or biochemical technologies in clinical diagnostics, for example, require facilities for processing liquid volumes and liquid samples. Automated facilities typically comprise a liquid handling apparatus, such as an individual pipetting device or multiple pipetting devices, which may be used on liquid containers which are located on the work table of a workstation or a so-called “liquid handling workstation”. Such workstations are often capable of executing greatly varying work on these liquid samples, such as optical measurements, pipetting, washing, centrifuging, incubation, and filtration. One or more robots, which operate according to Cartesian or polar coordinates, may be used for the sample processing on such a workstation Such robots may carry and rearrange liquid containers, such as sample tubes or microplates. Such robots may also be used as “robotic sample processors” (RSP), for example, as a pipetting apparatus for aspirating and dispensing, or as a dispenser for distributing liquid samples. Such facilities are preferably monitored and controlled by a computer. A decisive advantage of such facilities is that large numbers of liquid samples may be processed automatically over long periods of time of hours and days, without a human operator having to engage in the processing process. Such facilities may process entire test series automatically. Such test series, such as the “ELISA tests” (ELISA=Enzyme-Linked Immuno Sorbent Assay; cf. “PSCHYREMBEL Klinisches Worterbuch [Clinical Dictionary]” Walter de Gruyter GmbH & Co. KG, Berlin 1999, 258th Edition) may no longer be ignored in current clinical diagnostics and live science research.

For automation, two procedures must be differentiated from one another in principle in liquid handling; the defined uptake (aspiration) and the subsequent delivery (dispensing) of liquid samples. The pipetting tip is typically moved by the experimenter or a machine between these procedures, so that the aspiration location of a liquid sample is different from its dispensing location. Preferably, only the liquid system is essential for the precision of dispensing or aspiration/dispensing, which comprises a pump (e.g., a diluter implemented as a syringe pump), a liquid line having end piece (pipette tip), and if required, a system liquid. The system liquid, which is assumed to be incompressible in a first approximation, extends the piston of the diluter in an elastic and non-rigid way. The diluter is preferably connected to the pipetting tip for this purpose via at least partially elastic “tubing”, which is preferably filled with system liquid. It is thus possible using such pipetting devices to aspirate or dispense samples having a volume of multiple milliliters, but also very small sample volumes of a few nanoliters, at a relatively large spatial distance to the diluter in a controlled and reproducible way. The liquids to be pipetted and their gases, are preferably not soluble in the system liquid.

### RELATED PRIOR ART

As disclosed, for example, in the European Patent of the current applicant having number EP 1 221 341 B1, the accuracy (ACC) and reproducibility (CV=coefficient of variation) of the dispensing or aspiration/dispensing of a liquid sample may be influenced by greatly varying parameters. Essentially two modes are differentiated between in pipetting, single pipetting and multi-pipetting. In the single pipetting mode, a liquid sample is aspirated and dispensed at another location. In the multi-pipetting mode, a larger liquid volume is aspirated once and subsequently dispensed in multiple—usually equivalent—portions (aliquots) at one or more different locations in various wells of a standard microtitration plate™, for example (trademark of Beckman Coulter, Inc., USA) or microplates. When pipetting liquids, the question of their type often arises i.e., of the physical features or constants of this liquid Classifying liquids on the basis of their physical constants, such as surface tension, viscosity, or vapor pressure, is therefore known from the prior art.

However, other parameters also play a central role in pipetting. In U.S. patent application Ser. No. 11/009,247 of the present applicant having the title “Pipetting apparatus with integrated liquid level and/or gas bubble detection”, the importance of the detection and/or the absence of gas bubbles is noted. Thus, it is known because of the differing vapor pressure that samples of water or acetone must be pipetted in entirely different ways, The surface tension of these solvents also differs greatly (cf. Table 1).

TABLE 1

| Solvent | Viscosity | Vapor pressure | Surface tension |
|---|---|---|---|
| (at 20° C.) | [mPas] | [hPa] | [mN/m] |
| Water | 1.002 | 23 | 72.8 |
| DMSO | 2.14 | 0.56 | 43.0 |
| Acetone | 0.32 | 240 | 23.3 |
| Ethanol | 1.2 | 59 | 22.3 |

It is obvious from Table 1 that the surface tension of acetone is very similar to, that of ethanol. Nonetheless, these two solvents are not to be treated identically during pipetting because of the very different values of their parameters of viscosity and/or vapor pressure.

It may be seen from the statements made up to this point that the system liquid in a liquid handling apparatus must allow reproducible pipetting and/or dispensing results. However, because the liquid samples to be pipetted or dispensed behave very differently, the system liquid itself may not also introduce additional variables into the system, which is complex in any case. In other words, the system liquid must always behave identically and predictably.

Methods for conditioning a system liquid for a liquid handling apparatus, such as delonization, demineralization, degassing, and temperature control, are known from the prior art. These techniques may be applied to a system liquid so that it may be provided in a fixed quality. Deionized and demineralized system liquids are relatively stable and may be stored and transported over longer periods of time. This is not the case with the temperature control of the system liquid to a specific temperature, which normally requires thermostatting. If the system liquid is water, for example, it is known that gases contained in the ambient air (such as N₂, O₂, and CO₂ above all) diffuse spontaneously into the water Tests for detecting the oxygen content of water are known, for example, under the name AQUAMERCK (MERCK KGaA, D-64293 Darmstadt, Germany). The solubility of gases in liquids and/or the vapor pressure of liquids are known to be temperature dependent.

Multiple methods for degassing liquids (eluents) for use in high-pressure liquid chromatography (HPLC) are known from laboratory technology. Such liquids may be degassed in a flask by:
Heating them and exposing them to a vacuum. The increased temperature and the reduced pressure reduce the solubility of existing gases in the liquid.
Subjecting them to irradiation by ultrasound and exposing them to vacuum. The increased movement of the particles and the reduced pressure reduce the solubility of existing gases in the liquid.
Subjecting them to a gas wash using helium gas. By introducing helium, which has a low solubility, the, dissolved gas molecules are displaced from the liquid. However, degassing using helium is a costly method and requires the use of helium in pressure cylinders, whose operating pressure of 200 bar is not appreciated in all laboratories.

A further method is conducting the liquid to be degassed through a vacuum chamber in gas-permeable tubing (PTFE). This method is called “online degassing”. Using such an online degasser, up to 10 ml of liquid per minute may be degassed. However, 30 to 40 ml of system liquid is routinely used solely when putting a pipetting device into operation to flush the tubing of a pipetting channel and thus free it of interfering air bubbles. A “flash” of system liquid is also used for flushing when changing the pipetting needles, 5 to 10 ml of system liquid being consumed in 4 to 5 seconds. It is obvious that significantly larger quantities of degassed system liquid are consumed than may be provided by an online degasser. The need for system liquid multiplies with the number of parallel channels.

Larger and smaller devices (cf., for example, EP 1 262 720) for degassing water in heating or cooling systems are known from domestic technology. In such heating or cooling systems, water, oil, or water having additives (to prevent its freezing) are used for the heat transfer. Gases (above all ambient air) are often dissolved in the liquid loops of these systems and encourage their corrosion in the interior of the lines. In order to avoid this harmful influence, the gases are regularly separated from the circulating liquid. Such a device comprises a degassing chamber for degassing water. The degassing chamber comprises an injection point, a drain line, and a gas drain line. The known devices are designed for integration in domestic technology systems and may not be used easily for conditioning a system liquid for a liquid handling apparatus.

From WO 97/14922, a system and method for degassing a liquid in an essentially closed system is known. A reflow system for reintroducing of degassed liquid into the degassing chamber is also disclosed therein. In addition, a device for degassing liquid media is known from EP 0 933 109 A2, which device comprises a container with a negative pressure and internals that support degassing. These internals are implemented as a splash wall, for example and a pump that produces the negative pressure in the degassing chamber is disclosed as well. Further, a compact gas/liquid separator for crude oil, comprising a collection chamber for the degassed crude oil, is known from U.S. Pat. No. 4,483,697.

### OBJECT AND SUMMARY OF THE INVENTION

The present invention is therefore based on the object of suggesting an alternative device for conditioning a system liquid for a liquid handling apparatus, using which larger quantities of system liquid may be provided.

This object is achieved according to the features of independent claim 1 by suggesting a device for conditioning a system liquid for a liquid handling apparatus which comprises a degassing chamber for degassing the system liquid. The degassing chamber comprises a system liquid injection point, a system liquid drain line, and a gas drain line. The device according to the present invention is characterized in that it comprises a collection chamber for degassed system liquid, which is spatially separated from the degassing chamber and which is connected via a recirculation pump to the system liquid drain line of the degassing chamber. Additional, preferred, and inventive features result from the dependent claims.

An advantage of the device according to the present invention is that only a slight partial vacuum is necessary to degas system liquid successfully. In addition, the use of pressurized gas cylinders, which are not well-liked and are not permitted in every case by the safety authorities, may be dispensed with.

### BRIEF DESCRIPTION OF THE DRAWINGS

The device according to the present invention will be explained in greater detail on the basis of schematic drawings of exemplary embodiments, which do not restrict the scope of the present invention.

FIG. 1 shows a vertical partial section through a device according to the present invention according to a first embodiment;

FIG. 2A shows a mobile facility for conditioning a system liquid for a liquid handling apparatus, which comprises a device according to the present invention according to the first embodiment;

FIG. 2B shows a liquid handling workstation having at least one liquid handling apparatus for pipetting or dispensing liquid samples with the aid of a system liquid, which comprises a device according to the present invention according to the first embodiment;

FIG. 3 shows a vertical partial section through a device according to the present invention according to a second embodiment;

FIG. 4 shows a vertical partial section through a device according to the present invention according to a third embodiment.

### DETAILED DESCRIPTION OF THE INVENTION

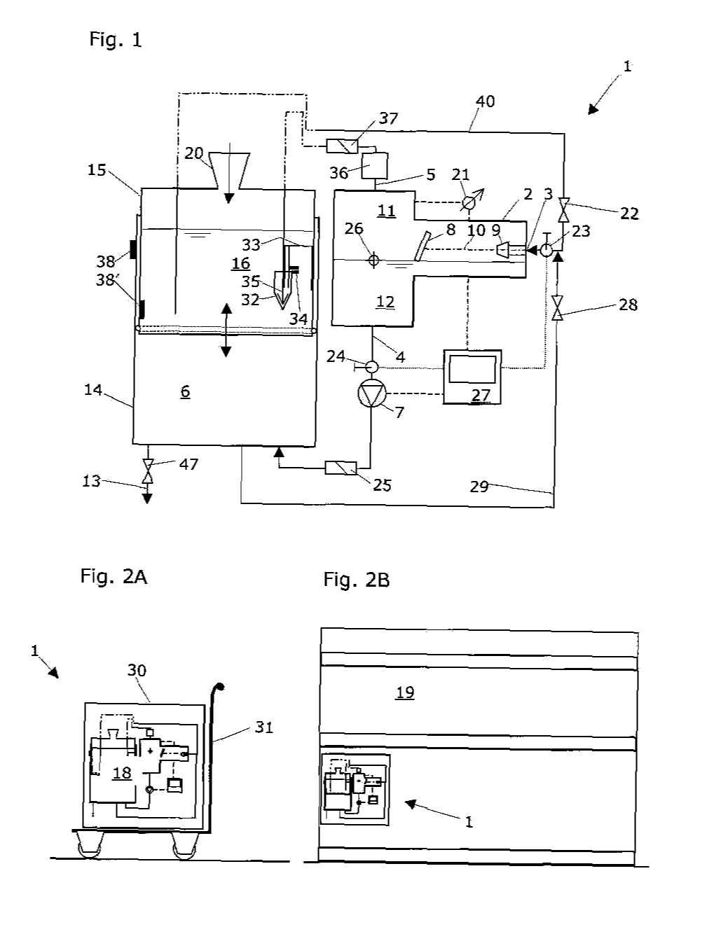

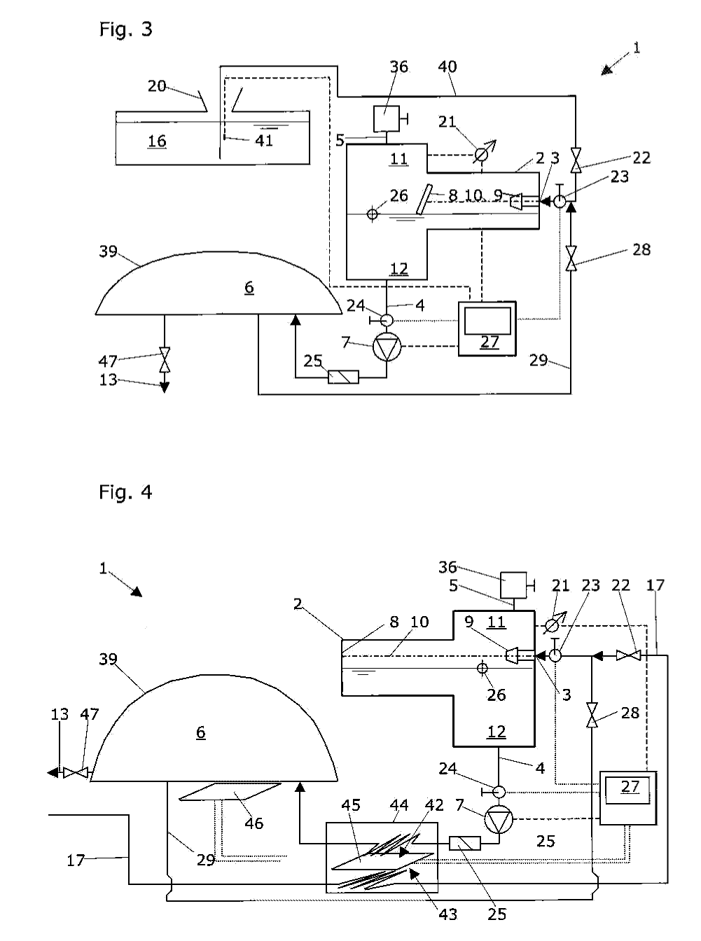

FIG. 1 shows a vertical partial section through a device according to the present invention according to a first embodiment. This device 1 for conditioning a system liquid for a liquid handling apparatus comprises a degassing chamber 2 for degassing the system liquid. The degassing chamber 2 itself comprises a system liquid injection point 3, a system liquid drain line 4, and a gas drain line 5. In addition, the device 1 comprises a collection chamber 6 for degassed system liquid. This collection chamber 6 is spatially separated from the degassing chamber 2 and connected via a recirculation pump 7 to the system liquid drain line 4 of the degassing chamber 2. The system liquid to be degassed enters the degassing chamber 2 at the injection point 3 via an injection nozzle 9. The device comprises a splash wall 8 in its degassing chamber 2. This splash wall 8 is preferably situated on an injection axis 10 running through the system liquid injection point 3 and its injection nozzle 9 in such a way that the injected system liquid impacts on the splash wall 8 and is swirled. This splash wall 8 may be identical to the wall of the degassing chamber 2 and run vertically (cf., for example, FIG. 4). If this splash wall 8 is inserted in the degassing chamber 2, as shown in FIGS. 1 and 3, it preferably encloses an angle with the injection axis 10, which is less than 90°, this angle preferably being directed upward, This configuration has the advantage in the embodiments shown in FIGS. 1 and 3 that the injection stream of the system liquid to be degassed, which essentially moves along the injection axis 10, is deflected so that it hits the walls of the degassing chamber 2 multiple times and is swirled efficiently.

In the first embodiment shown in FIG. 1, the degassing chamber 2 comprises a gas outflow connecting piece 11, which is situated above the injection nozzle 9 and after the injection nozzle 9 in the injection direction. In addition, the degassing chamber 2 comprises a system liquid intake connecting piece 12 here, which is situated below the injection nozzle 9 and after the injection nozzle 9 in the injection direction. This gas outflow connecting piece 11 and this system liquid intake connecting piece 12 preferably represent a cylinder with a part of the degassing chamber 2 lying between them, into which the remaining part of the degassing chamber 2, which is also cylindrical, discharges at a right angle. This construction is very simple and therefore cost-effective to implement.

The injection nozzle 9 and the splash wall 8 are situated symmetrically on the injection axis 10 here. This injection axis 10 is precisely identical to the cylinder axis of the remaining (horizontally running) part of the degassing chamber 2. Notwithstanding this illustration, the injection nozzle may also lie above or below the cylinder axis of the remaining (horizontally running) part of the degassing chamber 2 (as shown in FIG. 4, for example). In addition, the splash plate or splash wall 8 may be profiled or situated eccentrically in relation to the injection axis 10, if, for example, the swirling may be improved even further in this way (not shown). In this first embodiment, the splash wall 8 is situated entirely in this cylindrical and horizontally running remaining part of the degassing chamber 2. This has the advantage that the deflected injection stream of the system liquid does not hit the opening for the gas drain line 5 in any case. If the splash wall 8 is situated entirely in this cylindrical and horizontally running remaining part of the degassing chamber 2, it may also be oriented vertically and thus enclose an angle of 90° with the injection axis 10 (not shown), The further the splash wall 8 is situated shifted toward the vertical cylinder, which is formed by the gas outflow connecting piece 11, the system liquid intake connecting piece 12, and the part of the degassing chamber 2 lying between them, the smaller the angle to be selected between the splash wall 8 and the injection axis 10. In this way, the deflected injection stream of the system liquid may be prevented from hitting the opening for the gas drain line 5.

The collection chamber 6 has an outlet 13 having a valve 47 for degassed system liquid and is implemented here as a chamber between two cylinders 14,15, which are movable one inside the other and are sealed to one another. The seal is preferably produced using an O-ring or a lip seal in a way known per se. In addition, the inner cylinder 15, whose floor forms the cover of the collection chamber 6, is preferably guided in the outer cylinder 14 in such a way that It may move without tilting. As shown, the outer cylinder 14 may be open on top, the inner cylinder 15 being able to move telescopically in the outer cylinder 14. The goal of this configuration is to provide a chamber for collecting the degassed system liquid, whose volume is variable and which is free of gas bubbles of any type. Such gas bubbles may, for example, contain air or components thereof in any arbitrary composition. It is thus important that the collection chamber 6 for degassed system liquid contains no gas (or as little as possible), which may diffuse again into the system liquid.

In the embodiment of the device according to the present invention shown in FIG. 1, the outer cylinder 14 is implemented as described as a collection chamber 6 for degassed system liquid. The inner cylinder 15 is simultaneously implemented as a reservoir chamber 16 for system liquid to be degassed. Therefore, the double cylinder 14,15 also fulfills a double function. This additionally has the advantage that the weight of the inner cylinder 15 (depending on the reserved system liquid to be degassed) presses with its weight on the collection chamber 6 for degassed system liquid, so that a certain pressure is built up at the outlet 13 having the valve 47. This pressure reduces the risk that after completed removal of degassed system liquid, air flowing backward may reach the collection chamber 6.

The system liquid to be degassed reaches the reservoir chamber 16 via a filling: funnel 20, for example, which makes filling easier for the operating personnel (see arrow). Alternatively, the reservoir chamber 16 may also be provided with a supply line and filled automatically (not shown). As soon as the valve 22 is opened, system liquid to be degassed flows into the degassing chamber 2. This inflow is preferably regulated using a throttle valve 23. The inflow is reinforced by the suction effect of the recirculation pump 7, which engages on the system liquid drain line 4. This suction effect is preferably also regulated using a throttle valve 24. The system liquid reaches the collection chamber 6 via the check valve 25. In order that this is possible, the recirculation pump 7 must at least generate a delivery pressure which is large enough to raise the weight of the inner cylinder 15 with filled reservoir chamber 16. The delivery line 40 and the gas drain line 5 are implemented as at least partially flexible (dot-dash lines), so that they may also perform the height movements of the inner cylinder 15.

System liquid may flow into the degassing chamber 2 at most until its level reaches the sensor 26. If this is the case, the sensor 26 communicates the maximum level status to the controller 27, which then closes the valve 22. After the valve 22 is closed, the recirculation pump 7 is turned off with a delay. A partial vacuum is thus generated in the degassing chamber 2, which is measured using a manometer 21. The pump 7 may be turned off with a time delay of a few minutes upon reaching a partial vacuum of 500 millibar or immediately upon reaching a partial vacuum of 150 millibar The partial vacuum causes additional degassing of the system liquid during a waiting time of approximately 1 to 2 minutes. A normal degassing cycle thus comprises a pump running time of approximately 3 to 5 minutes and a standstill time of approximately half this time.

Before the pump 7 is put back into operation, the valve 22 is opened again. Because there is still a partial vacuum in the degassing chamber 2, the system liquid sprays at great velocity into the degassing chamber 2, hits the splash wall 8 therein, and is swirled strongly. Simultaneously, the recirculation pump 7 is put back into operation and degassed system liquid is pumped out of the degassing chamber 2 into the collection chamber 6. Depending on the volume flow rate set in the throttle valves 23 and 24, the valve 22 is closed again after a few minutes and the pump is shut down again after reaching a specific partial vacuum (preferably 150 millibar). When pump 7 is turned off, the check valve 25 prevents degassed system liquid from being able to flow back into the degassing chamber 2. As symbolized by the interrupted lines in FIG. 1, the throttle valves 23 and 24, the manometer 21, and the pump 7 are connected to the controller 27.

This controller is preferably a computer, which may be a part of the device 1, for example. Such a device 1 may, for example, be housed in a suitable housing 30 and situated on a rolling truck 31 (cf. FIG. 2A). Such a mobile facility 18 for conditioning a system liquid for a liquid handling apparatus comprises at least one device 1 and is connectable to at least one liquid handling apparatus.

However, the device 1 may also be integrated in a liquid handling workstation 19 having at least one liquid handling apparatus for pipetting or dispensing liquid samples with the aid of a system liquid (cf. FIG. 2B). This liquid handling workstation comprises at least one device 1 for conditioning the system liquid. A liquid handling workstation 19 and/or a cluster comprising multiple workstations may also comprise multiple such devices, however. Depending on the conditions, the controller 27 may communicate with the controller of the workstation or may be installed directly therein.

After this procedure has been repeated multiple times, a certain volume of up to multiple liters of system liquid is located in the collection chamber 6. This volume may be provided, via the outlet 13 having the valve 47, to a liquid handling apparatus for pipetting or dispensing liquid samples with the aid of a system liquid, However, this volume may also again be subjected to a degassing cycle. The degassing procedure is then accordingly repeated multiple times, the valve 28 being opened or closed in each case: instead of the valve 22 (as just described). This valve 28 terminates the return line 29, which also discharges via the throttle valve 23 into the system liquid injection point 3.

The reservoir chamber 16 for system liquid to be degassed may be equipped with a float 32. This float 32 is preferably submerged constantly in the system liquid (cf. FIG. 1) or immersed in the system liquid (not shown). The float 32 is preferably attached to a suspension 33 so it may not twist and so it is displaceable in height. A proximity sensor 34 indicates that the reservoir chamber 16 is sufficiently filled for the operation of the device 1. A capillary 35, which is connected to the gas drain line 5, discharges into the float 32. If gas flows via the gas drain line 5, the aspirator 36, and the check valve 37 into the capillary 35 during injection of system liquid into the degassing chamber 2, such a large gas flow results due to the low capillary diameter that the float 32 is pressed downward somewhat. This path of the float 32 corresponding to this gas flow is indicated to the controller via the proximity sensor 34. If there is no buoyancy for the float 32, an alarm is triggered so that the reservoir chamber 16 is refilled again. An automatic refilling procedure may thus also be triggered.

Overfilling of the collection chamber 6 is avoided in that a proximity switch having two elements 38,38′ indicates the highest fill level of the collection chamber 6. One element 38 or 38′ is attached to each of the two cylinders 14,15 movable one inside the other.

FIG. 3 shows a vertical partial section through a device 1 according to the present invention according to a second embodiment. This differs from the first embodiment essentially in that the reservoir chamber 16 and the collection chamber 6 are completely functionally separated from one another. In addition, the collection chamber 6 is implemented as a chamber in a flexible bag 39. It is also the goal of this configuration to provide a chamber for collecting the degassed system liquid, whose volume is variable and which is free of gas bubbles of any type. Such gas bubbles may contain air or components thereof in any arbitrary composition, for example. The bag may be made of stretchable material, but it may also be folded like a bellows. It is thus important that the collection chamber 6 for the degassed system liquid contains no (or as little as possible) gas, which may diffuse again into the system liquid. The delivery line 40 is immersed here in the filling funnel 20 of the reservoir chamber 16 and defines the lowest reachable level in this reservoir chamber 16. An alarm to communicate the need for refilling the reservoir chamber 16 is triggered here via a liquid sensor 41. The aspirator 36 is implemented here as a one-way overpressure valve.

FIG. 4 shows a vertical partial section through a device 1 according to the present invention according to a third embodiment. This differs from the first embodiment essentially in that it does not comprise a reservoir chamber 16, but rather a supply line 17 for the system liquid to be degassed. In addition, the collection chamber 6 is implemented as a chamber in a flexible bag 39. It is also the goal of this configuration to provide a chamber for collecting the degassed system liquid whose volume is variable and which is free of gas bubbles of any type. Such gas bubbles may contain air or components thereof in any arbitrary composition, for example. The bag may be made of stretchable material, but it may also be folded like a bellows. It is thus important that the collection chamber 6 for degassed system liquid contains no (or as little as possible) gas, which may diffuse again into the system liquid. The aspirator 36 is implemented here as a one-way overpressure valve. The vapor pressure of a liquid and the solubility of gases in a liquid are a function of the ambient pressure and the temperature of the liquid. In order to improve the degassing rate of the system liquid, the pressure in the degassing chamber 2 is not only lowered to a range of approximately 500 millibar to 150 millibar. The following table is to show how the vapor pressure is a function of the system liquid temperature:

TABLE 2

| | Vapor pressure | | |
|---|---|---|---|
| | [hPa] or [mbar] | | |
| System liquid | 50° C. | 80° C. | 100° C. |
| Water | 150 | 500 | 1000 |
| Ethanol | 300 | 1000 | — |

It is obvious from Table 2 that water already boils at a temperature of 80° C. at a degasser pressure of 500 millibar. Ethanol already boils at a degasser pressure of 300 millibar and a temperature of 50° C. The following table is to show how the solubility of gases is a function of the system liquid temperature (water temperature here):

TABLE 3

| | Solubility [ml/l H₂O] | | |
|---|---|---|---|
| Gas | 0° C. | 12° C. | 24° C. |
| N₂ | 23.00 | 17.8 | 14.6 |
| O₂ | 49.24 | 36.75 | 29.4 |
| CO₂ | 1715 | 1118 | 782 |

It is obvious from Table 3 that the solubility of these gases in water is reduced by approximately a factor of 1.5 to 2.2 upon a temperature increase of 24° C. At a temperature of 50° C., a reduction of the solubility by approximately a third in relation to 24° C. is assumed.

Thus, when the pressure in the degassing chamber 2 is lowered and, in addition, the temperature of the system liquid to be degassed is increased, these two measures support the degassing of the system liquid. The system liquid is preferably heated to approximately 50° C. for this purpose. This temperature is approximately 25° higher than that which the system liquid has upon use during the pipetting and/or dispensing. It is advantageous if the system liquid is cooled back to the typical usage temperature after the degassing. The system liquid to be degassed is preferably heated via a heater 42 and the degassed system liquid is preferably cooled via a cooler 43. The lines which supply system liquid to be degassed to the injection nozzle 9 (such as the line 40 in FIG. 1 or the line 17 in FIG. 4) are especially preferably guided in meandering loops over the heating side 42 of a heating-cooling apparatus 44. The lines which supply degassed system liquid to the collection chamber 6 (such as the line 4 in FIGS. 1, 3, and 4) are also guided in meandering loops over the cooling side 43 of the same heating-cooling apparatus 44. This heating-cooling apparatus 44 especially preferably comprises at least one Peltier element 45, which is situated between the two cited meandering loops in such a way that the system liquid to be degassed is heated and the system liquid already degassed is simultaneously cooled. An additional Peltier element 46 or another suitable unit may be used in combination with the controller 27 as a thermostat for thermostatting and/or controlling the temperature of the degassed system liquid in the collection chamber 6.

The third embodiment of the device 1 according to the present invention discussed here is a refinement of the domestic technology degassing device disclosed in EP 1 262 720 B1. However, there is no indication therein of such essential features as a collection chamber 6 being spatially separated from the degassing chamber and/or having variable volume, a heating-cooling apparatus 44, or the use of Peltier elements, for example. These features of the third embodiment of the device according to the present invention for conditioning a system liquid for a liquid handling apparatus have already been described in this application. As also described in document EP 1 262 720 B1, in the third embodiment of the device according to the present invention, a relatively large liquid surface is to be provided and good swirling thereof is to be achieved during the injection of the system liquid to be degassed. It is important that the stream of the system liquid sprayed from the injection nozzle 9 is a bundled, sharp stream. The stream thus impacts on the diametrically opposite splash wall 8 of the degassing chamber 2 and does not catch the system liquid in the degassing chamber 2, so that it would spray on one side. The system liquid intake connecting piece could thus be exposed, so that the pump 7 would even take in air. The injection effect by impact of the thin stream on the splash wall 8 causes swirling of the entire surface of the system liquid in the degassing chamber 2. The system liquid is atomized by this impact, which results in increased outgassing. This atomizing is preferably supported, as already noted, by the existing partial vacuum and increased temperature of the system liquid. In this third embodiment, it is important that the gas outflow connecting piece 11 is situated offset slightly to the rear over the injection nozzle 9, so that its central axis lies somewhat behind the nozzle mouth. The aspirator 36 is thus emptied immediately by the injector effect if any system liquid is present therein. This is also the area where an empty space remains in existence until the end during filling of the degassing chamber 2, because the gases collect and enter the aspirator 36 unobstructed. The free gases are only separated via the aspirator 36 when the system liquid flows after.

Outstanding outgassing is nonetheless achieved by this configuration at a partial vacuum of the degassing chamber 2 of only 800 millibar to 500 millibar. The pressure values for the operation are adjustable at the throttle valve 24, which may also be implemented as a pressure adjustment screw. The fact that the operation of this device manages with very slight partial vacuum additionally provides the advantage that the pump 7 does not come into the gravitation range and thus remains protected. In order that the vacuum is not permitted to fall below 500 millibar, it is controlled electronically by the control unit 27. The partial vacuum may be monitored using a pressure sensor or using a pressure switch. In the application using the pressure switch, the vacuum generated by the pump 7 is monitored in that the pump is turned off with a time delay after falling below 500 millibar. A normal degassing cycle comprises a pump running time of 3.5 minutes and a standstill time of 1.5 minutes. If the vacuum falls below the value of 500 millibar, the pump turns off after 1.5 minutes. This time delay is preferably adjustable in the menu of the controller 27. In the version having the pressure sensor, the shutdown is performed in a staggered way. The trigger point is again a partial vacuum. At a value of 500 millibar, a first time-controlled period of at most 3.0 minutes running time until reaching 350 millibar comes into effect. If the pressure falls below 350 millibar, however, a second time control is activated, which only still permits a maximum running time of 1.5 minutes. If the vacuum reaches a value of 200 millibar, the pump 7 is shut down immediately. These times are also adjustable in the menu of the controller 27. The control described provides the advantage that in the event of poor basic setting of the vacuum, or if the set value changes, the device still runs optimally controlled.

The system liquid connecting piece 12 to the pump 7 is located precisely below the injection nozzle 9. This is implemented as so large that plentiful system liquid always reaches the pump 7, by which a dry-running protector is implemented. In this example shown, the supply line 17 thus discharges via the injection nozzle 9 into the upper half of the inner chamber of the degassing chamber 2. The pump 7 having integrated pressure regulator delivers system liquid from the degassing chamber 2, because of which a partial vacuum arises therein. As soon as a pressure difference has resulted between the interior of the degassing chamber 2 and the supply line 17, the valve 22 may be opened and system liquid begins to flow via the injection nozzle 9 into the degassing chamber 2. The system liquid flowing through the nozzle 9 reaches a high velocity because of the nozzle 9 and a stream effect arises. According to Bernoulli's law, a strong partial vacuum thus arises in the stream and also above the nozzle 9, which empties the aspirator 36 of any system liquid present therein very rapidly. Since, as a result of the pump output, more system liquid is suctioned from the degassing chamber 2 than flows in through the injection nozzle 9, a partial vacuum arises in the degassing chamber 2. By regulation at the pressure adjustment screw at the pump head, a uniform volume flow rate in the partial vacuum of the system liquid to be degassed is achieved.

Efficient degassing is already made possible by operation using a very small degassing chamber 2 having a content of less than one liter. Even using such a small degassing chamber 2, degassing may be performed for up to 5 minutes without interruption. The recirculation pump 7 is then shut down for 90 seconds in order to expel the released gas via the aspirator 36. The composition of the recirculation pump 7 permits only a minimal backflow of system liquid. However, this backflow is sufficient to cause any gases, which have collected in the pump head to rise back into the degassing chamber 2. However, the main component of liquid flows via the injection nozzle 9 into the degassing chamber 2 after shutdown of the recirculation pump 7, which in turn causes a pressure increase in its interior. As soon as a pressure of 1010 bar has been exceeded in the degassing chamber 2, all free gases are expelled via the aspirator 36.

In a fourth device 1 according to the present invention (not shown), the system liquid drain line 4 and the return line 29 (cf. FIGS. 1, 3, and 4) are attached to a cover for a system liquid canister. Such system liquid canisters are known per se and have been used for years, typically having a volume of 10, 20, or 30 l. The system liquid drain line 4 and the return line 29 are preferably equipped in such a way that they nearly touch the, floor of the system liquid canister when the cover is placed or screwed on and are thus designed as immersion pipes. A system liquid canister connected to the degassing chamber 2 in this way represents an alternative collection chamber 6 for degassed system liquid. Thanks to this configuration, degassed system liquid delivered by the recirculation pump 7 may be stored in the system liquid canister. Circulation and repeated injection of the system liquid into the degassing chamber 2 is also possible. To avoid overpressure in the system liquid canister, an overpressure valve or simple opening for pressure equalization is preferably also provided in the cover.

To transport the system liquid canister and connect it to, for example, an individual pipetting device, the cover having the system liquid drain line 4 and having the return line 29 is preferably removed and replaced by a suitable transport cover (which is preferably completely sealed) or by a removal cover (which preferably only has a single immersion tube for removing system liquid). The removal cover preferably also has a simple opening or an inlet filter, via which a gas or ambient air may penetrate into: the system liquid canister, so that no partial vacuum forms therein when the system liquid is removed.

The features described above of the various embodiments of the devices according to the present invention may be combined practically arbitrarily, so that such combinations, but also leaving out less essential features, are within the scope of the present invention. The reference numerals each identify identical or corresponding parts of the device according to the present invention, even if these are not described specifically in each case.

### EXEMPLARY APPLICATION

Water was used as a system liquid in the degassing chamber of a prototype according to the present invention. The oxygen content in the water was measured as an example for the completed degassing. After half an hour of degassing (without additional heating of the water) the water contained 1.9 mg O₂/l at room temperature. After multiple hours of operation, an oxygen content of only 1.1 to 1.3 mg O₂/l could still be measured. As a comparative experiment, standard helium degassing was performed, after which an oxygen content of 4.1 to 4.5 mg O₂/l was measured. This result indicates that the device according to the present invention already provides a result after a short degassing time of 30 minutes, which is better by more than a factor of 2 than the degassing result using the known helium method.

In addition, it was able to be established that not only gas bubbles influence the precision of the pipetting; even gases dissolved in the system liquid contribute to worsening the reproducibility, i.e., to increasing the CV value during the dispensing of a liquid sample. Such gases are typically the gases contained in the ambient air, above all N₂, O₂, CO₂ and possibly noble gases. The CV values achieved which were performed in pipetting series using the water degassed according to the present invention as a system liquid were always lower than those which were achieved using non-degassed water.

### LIST OF REFERENCE NUMERALS

1 device
2 degassing chamber
3 system liquid injection point
4 system liquid drain line
5 gas drain line
6 collection chamber for degassed system liquid
7 recirculation pump
8 splash wall
9 injection nozzle
10 injection axis
11 gas outflow connecting piece
12 system liquid intake connecting piece
13 outlet
14 outer cylinder
15 inner cylinder
16 reservoir chamber for system liquid to be degassed
17 supply line for the system liquid to be degassed
18 mobile facility
19 liquid handling workstation
20 filling funnel
21 manometer
22 valve
23 throttle valve
24 throttle valve
25 check valve
26 sensor
27 controller
28 valve
29 return line
30 housing
31 rolling truck
32 float
33 suspension
34 proximity sensor
35 capillary
36 aspirator
37 check valve
38 proximity switch having two elements 38,38′
39 flexible bag
40 delivery line
41 liquid sensor
42 heater, heating side
43 cooler, cooling side
44 heating-cooling apparatus
45 Peltier element
46 additional Peltier element
47 valve

What is claimed is:

1. A device (1) for conditioning a system liquid for a liquid handling apparatus, which comprises a degassing chamber (2) for degassing the system liquid, the degassing chamber (2) comprising a system liquid injection point (3), a system liquid drain line (4) and a gas drain line (5),
wherein the device comprises a collection chamber (6) for degassed system liquid, which is spatially separated from the degassing chamber (2) and which is connected via a recirculation pump (7) to the system liquid drain line (4) of the degassing chamber (2).

2. The device (1) according to claim 1,
wherein the degassing chamber (2) comprises a splash wall (8), which is situated on an injection axis (10) running through the system liquid injection point (3) and its injection nozzle (9) in such a way that the injected system liquid impacts on the splash wall (8) and is swirled.

3. The device (1) according to claim 2,
wherein the splash wall (8) encloses an angle with the injection axis (10), which is less than 90°, this angle preferably being directed upward.

4. The device (1) according to claim 2,
wherein the degaussing chamber (2) comprises a gas outflow connecting piece (11), which is situated above the injection nozzle (9) and in the injection direction after the injection nozzle (9).

5. The device (1) according to claim 2,
wherein the degassing chamber (2) comprises a system liquid intake connecting piece (12), which is situated below the injection nozzle (9) and in the injection direction after the injection nozzle (9).

6. The device (1) according to the claim 4,
wherein the gas outflow connecting piece (11) and the system liquid intake connecting piece (12) represent a cylinder with a part of the degassing chamber (2) lying between them, into which the remaining part of the degassing chamber (2), which is also cylindrical, discharges at a right angle.

7. The device (1) according to claim 6,
wherein the injection nozzle (9) and the splash wall (8) are situated symmetrically on the injection axis (10), this injection axis (10) being identical to the cylinder axis of the remaining part of the degassing chamber (2).

8. The device (1) according to claim 6,
wherein the splash wall (8) is situated at least partially in this cylindrical remaining part of the degassing chamber (2).

9. The device (1) according to claim 1,
wherein the collection chamber (6) has an outlet (13) for degassed system liquid and is implemented as a chamber between two cylinders (14,15), which are movable one inside the other end are sealed to one another, or as a chamber in a flexible bag.

10. The device (1) according to claim 9,
wherein the outer cylinder (14) is implemented as a collection chamber (6) for degassed system liquid and the inner cylinder (15) is implemented as a reservoir chamber (16) for the system liquid to be degassed.

11. The device (1) according to claim 1,
wherein the collection chamber (6) is implemented as an individually transportable system liquid canister.

12. The device (1) according to claim 1,
which comprises a reservoir chamber (16) or a supply line (17) for the system liquid to be degassed.

13. The device (1) according to claim 1,
which comprises a heater (42) for the system liquid to be degassed and/or a cooler (43) for the degassed system liquid.

14. The device (1) according to claim 13,
wherein the heater (42) for the system liquid to be degassed and the cooler (43) for the degassed liquid are integrated in a heating-cooling apparatus (44), the heating-cooling apparatus (44) comprising at least one Peltier element (45).

15. The device (1) according to claim 1,
which comprises a thermostat for thermostatting or controlling the temperature of the degassed system liquid in the collection chamber (6).

16. A mobile facility (18) for conditioning a system liquid for a liquid handling apparatus,
wherein the mobile facility comprises at least one device (1) according to claim 1 that is connectable to at least one liquid handling apparatus.

17. A liquid handling apparatus for pipetting or dispensing liquid samples with the aid of a system liquid,
wherein this liquid handling apparatus comprises at least one device (1) for conditioning the system liquid according to claim 1.

18. A liquid handling workstation (19) having at least one liquid handling apparatus for pipetting or dispensing liquid samples with the aid of a system liquid,
wherein this liquid handling workstation comprises at least one device (1) for conditioning the system liquid according to claim 1.

19. A use of a device (1) for conditioning, particularly for degassing, a system liquid for a liquid handling apparatus, according to claim 1.
